(19) United States
(12) Patent Application Publication
(10) Pub. No.: US 2025/0242233 A1
(43) Pub. Date: Jul. 31, 2025

(54) OPERATION DEVICE, INFORMATION PROCESSING APPARATUS, INFORMATION PROCESSING METHOD, AND PROGRAM

(71) Applicant: Sony Interactive Entertainment Inc., Tokyo (JP)

(72) Inventors: Takashi Enokihara, Ibaraki (JP); Tomoyuki Okubo, Saitama (JP); Yoshiaki Takagi, Tokyo (JP); Takafumi Ogura, Chiba (JP)

(73) Assignee: Sony Interactive Entertainment Inc., Tokyo (JP)

(21) Appl. No.: 18/721,739

(22) PCT Filed: Jan. 31, 2023
(86) PCT No.: PCT/JP2023/003115

§ 371 Date: Jun. 19, 2024

(30) Foreign Application Priority Data
Jan. 31, 2022 (WO) PCT/JP2022/003639

(51) Int. Cl. A63F 13/22; A63F 13/24

(52) U.S. Cl. CPC A63F 13/22; A63F 13/24

(57) ABSTRACT

An operation device includes a direction indication operation member that is subjected to a user depression operation toward any direction, and an operation member that is different in category from the direction indication operation member. The operation device generates operation data that includes operation information describing operations on the direction indication operation member and the operation member of the different category, and transmits the operation data to an information processing apparatus. In a case where a use request for an alternative input function of using the direction indication operation member as an alternative to the operation member of the different category is given, operation information describing an operation on the operation member of the different category to be included in the operation data is identified according to a user operation performed on the direction indication operation member.

### TECHNICAL FIELD

The present invention relates to an operation device that accepts a user operation input, an information processing apparatus, an information processing method, and a program.

### BACKGROUND ART

For example, an operation device that is connected to an information processing apparatus such as a home-use video game is typically equipped with a plurality of operation members such as operation buttons. Specific functions are allocated to the respective operation members. By operating an operation member corresponding to a function to be executed, a user gives an instruction to the information processing apparatus. In a case where a plurality of operation buttons are used, however, the operability of the operation buttons may be different for each user due to the arrangement positions of the buttons. For this reason, a technology of allowing a user to optionally change which function is allocated to each operation button has been proposed.

### SUMMARY

### Technical Problem

In the above conventional technology, a function allocation change among operation members (e.g. operation buttons) of the same category which correspond to operation inputs of the same category can be made, but a function allocation change to an operation member of a different category cannot be made. When operation members are different in categories from each other, operations that the operation members can input are also different. It is difficult to use, as an alternative to a certain operation member, an operation member of a different category. However, some people like to use operation members of a specific category. If so, the above-mentioned conventional technology is insufficient to improve the convenience of some users.

The present invention has been made in view of the above circumstances, and one object thereof is to provide an operation device, an information processing apparatus, an information processing method, and a program by which user convenience can be improved.

### Solution to Problem

An operation device according to the present invention is connected to an information processing apparatus. The operation device includes a direction indication operation member that is subjected to a user depression operation toward any direction, an operation member that is different in category from the direction indication operation member, an operation data generation section that generates operation data that includes operation information describing operations on the direction indication operation member and the operation member of the different category, and an operation data transmission section that transmits the operation data to the information processing apparatus, in which in a case where a use request for an alternative input function of using the direction indication operation member as an alternative to the operation member of the different category is given, the operation data generation section identifies operation information describing an operation on the operation member of the different category to be included in the operation data, according to a user operation performed on the direction indication operation member.

An information processing apparatus according to the present invention is connected to an operation device including a direction indication operation member that is subjected to a user depression operation toward any direction, and an operation member that is different in category from the direction indication operation member. The information processing apparatus includes an acceptance section that accepts, from the user, a use request for an alternative input function of using the direction indication operation member as an alternative to the operation member of the different category, and a transmission section that transmits information describing the accepted use request to the operation device.

An information processing method according to the present invention is for causing a computer to perform steps. The computer is connected to an operation device including a direction indication operation member that is subjected to a user depression operation toward any direction, and an operation member that is different in category from the direction indication operation member. The steps include a step of accepting, from the user, a use request for an alternative input function of using the direction indication operation member as an alternative to the operation member of the different category, and a step of transmitting information describing the accepted use request to the operation device.

A program according to the present invention causes a computer to perform steps. The computer is connected to an operation device including a direction indication operation member that is subjected to a user depression operation toward any direction, and an operation member that is different in category from the direction indication operation member. The steps include a step of accepting, from the user, a use request for an alternative input function of using the direction indication operation member as an alternative to the operation member of the different category, and a step of transmitting information describing the accepted use request to the operation device. This program may be provided in a state of being stored in a computer readable and non-temporal information recording medium.

### BRIEF DESCRIPTION OF DRAWINGS

FIG. 1 is an overall configuration diagram of an information processing system including an operation device according to an embodiment of the present invention.

FIG. 2 is a diagram depicting one example of an external appearance of the operation device according to the embodiment of the present invention.

FIG. 3 is a functional block diagram depicting functions that are implemented in the information processing system.

FIG. 4 is a diagram depicting one example of operation data.

FIG. 5 is a diagram for explaining information on an operation on a tilting operation member.

FIG. 6 is a diagram for explaining a case where the tilting operation member is used as an alternative to one operation button.

FIG. 7 is a diagram for explaining a case where the tilting operation member is used as an alternative to a plurality of operation buttons.

FIG. 8 is a diagram for explaining a case where the tilting operation member is used as an alternative to a plurality of direction indication buttons.

FIG. 9 is a diagram for explaining a case where the tilting operation member is used as an alternative to a plurality of functional buttons and direction indication buttons.

### DESCRIPTION OF EMBODIMENT

Hereinafter, an embodiment according to the present invention will be explained in detail with reference to the drawings.

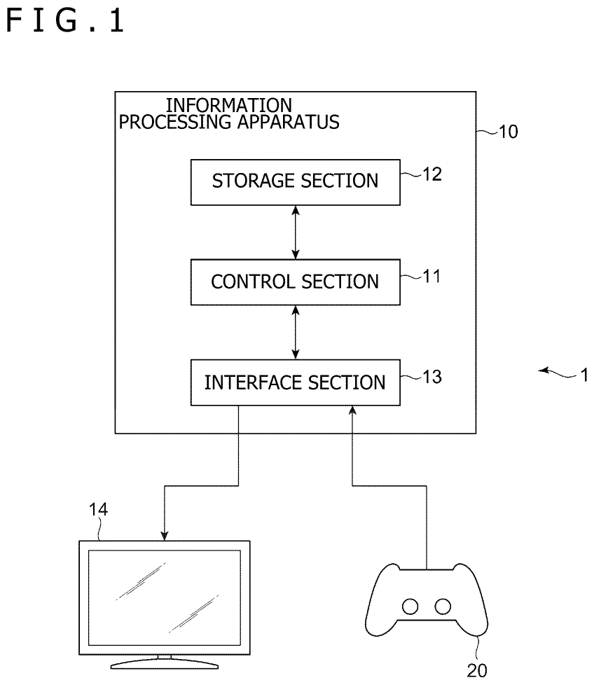

FIG. 1 is an overall configuration diagram of an information processing system 1 including an operation device 20 according to one embodiment of the present invention. As depicted in FIG. 1, the information processing system 1 includes an information processing apparatus 10, a display apparatus 14, and the operation device 20.

The information processing apparatus 10 is a home-use game machine or a personal computer, for example. The information processing apparatus 10 includes a control section 11, a storage section 12, and an interface section 13. In addition, the information processing apparatus 10 is connected to the display apparatus 14 and the operation device 20.

The control section 11 includes at least one processor, and executes various kinds of information processing in accordance with a program stored in the storage section 12. The storage section 12 includes at least one storage element, and stores the program to be executed by the control section 11, and data to be subjected to the various kinds of processing based on the program. Specific examples of processing to be executed by the control section 11 in the present embodiment will be explained later.

The interface section 13 includes a communication interface for exchanging information with the display apparatus 14 and the operation device 20. Via the interface section 13, the information processing apparatus 10 receives a variety of pieces of information such as operation data from the operation device 20, and transmits a variety of control commands to the operation device 20. It is to be noted that data exchange between the information processing apparatus 10 and the operation device 20 may be performed through wireless communication based on the Bluetooth (registered trademark) standard, or communication connection between the information processing apparatus 10 and the operation device 20 may be established wiredly in compliance with a universal serial bus (USB) standard or the like. In addition, the interface section 13 supplies, to the display apparatus 14, a video signal including video information to be displayed.

The display apparatus 14 is a home-use television receiver, for example. The display apparatus 14 displays a video according to video signals transmitted from the information processing apparatus 10.

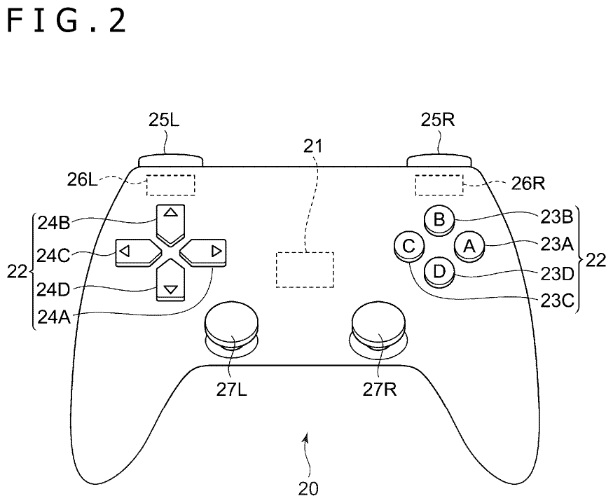

The operation device 20 is a controller for home-use game machines, for example. The operation device 20 is used to accept an operation input from a user. FIG. 2 depicts one example of the external appearance of the operation device 20. In the present embodiment, the operation device 20 includes a control circuit 21, a plurality of operation buttons 22, a plurality of trigger buttons 25, a plurality of force presenting mechanisms 26, and a plurality of tilting operation members 27. Further, in the present embodiment, the operation buttons 22 include four functional buttons 23 and four direction indication buttons 24.

The control circuit 21 includes a microcontroller, etc., and executes processes for controlling the sections in the operation device 20. Specifically, the control circuit 21 outputs a control signal for activating the force presenting mechanisms 25 in accordance with a control command received from the information processing apparatus 10. In addition, the control circuit 21 identifies a user operation by scanning the statuses of the operation members disposed on the operation device 20 at regular intervals, and transmits operation data D that describes the operation to the information processing apparatus 10.

The operation buttons 22 are operation members that are depressed by a user. Regarding the operation buttons 22, the control circuit 21 identifies only whether or not the operation buttons 22 are depressed by a user. That is, when each of the operation buttons 22 is depressed, the control circuit 21 identifies the depression.

Each of the functional buttons 23 is one of the operation buttons 22, and is used to implement a certain function in an application program being run by the information processing apparatus 10. In the present embodiment, the operation device 20 includes four functional buttons 23 which are functional buttons 23A, 23B, 23C, and 23D. Functions allocated to these functional buttons 23 may be different in each application program.

Each of the direction indication buttons 24 is one of the operation buttons 22, and is used by a user to indicate a direction. Specifically, the operation device 20 includes four direction indication buttons 24 which are a right-direction indication button 24A, an up-direction indication button 24B, a left-direction indication button 24C, and a down-direction indication button 24D. When a user depresses one of the direction indication buttons 24, the depression is treated as a user indication of a direction corresponding to the depressed direction indication button 24. In addition, when the user depresses two adjacent direction indication buttons 24 at the same time, the depression is treated as an indication of a middle direction between the directions corresponding to the two depressed direction indication buttons 24. When the user depresses the right-direction indication button 24A and the down-direction indication button 24D at the same time, for example, an application being run by the information processing apparatus 10 interprets that the user indicates a lower right direction, and executes a process corresponding to the indicated direction.

Like the operation buttons 22, the trigger buttons 25 are operation members to be depressed by the user. Unlike the operation buttons 22, however, each of the trigger buttons 25 is configured to be able to measure a depression amount which indicates an amount by which the user has depressed the trigger button. Specifically, each of the trigger buttons 25 includes a movable section that is movable within a certain range, and a measurement section that measures an amount of movement of the movable section according to a user operation. The control circuit 21 identifies the depression amount of a user operation by using a measurement result obtained by the measurement section. The value of the depression amount is added to operation data D so that the information processing apparatus 10 can execute a process according to a user operation of slightly depressing a trigger button 25 or greatly depressing a trigger button 25. In the present embodiment, the operation device 20 includes left and right trigger buttons 25L and 25R.

Moreover, in the present embodiment, the force presenting mechanisms 26 are connected to the respective trigger buttons 25. The force presenting mechanisms 26 each present a force to a user body when the user performs a depressing operation on the corresponding trigger button 25. With the force presenting mechanisms 26, forces resisting to a user operation of depressing the trigger buttons 25 can be presented.

The tilting operation members 27 can be tilted to any direction by a user. The operation device 20 of the present embodiment includes left and right tilting operation members 27L and 27R. The tilting operation members 27 each include a movable section that is projected from a surface of a casing of the operation device 20. By pushing the movable section with a finger of a left/right hand, the user can tilt the tilting operation member 27 to any direction of 360 degrees. When the user is applying no force to the movable section, the movable section is automatically urged to be restored to the center position (neutral position). The control circuit 21 identifies the direction and the amount of a user operation of tilting each of the tilting operation members 27. It is to be noted that the details of a manner of identifying a user operation on the tilting operation members 27 will be explained later.

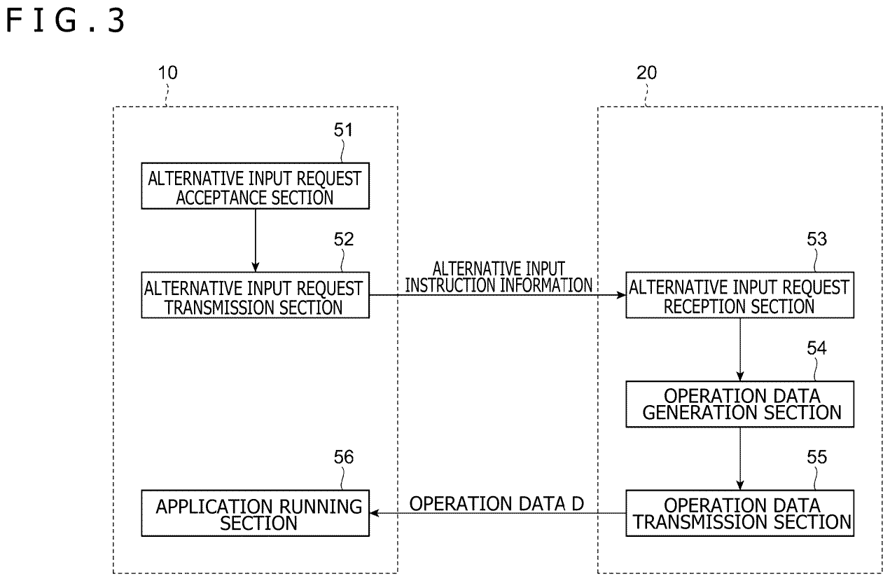

Hereinafter, according to the embodiment, functions that are implemented by the information processing apparatus 10 and the operation device 20 will be explained with reference to a functional block diagram in FIG. 3. As depicted in FIG. 3, the information processing apparatus 10 includes an alternative input request acceptance section 51, an alternative input request transmission section 52, and an application running section 56 in terms of functions. These functions are implemented by the control section 11 executing a program stored in the storage section 12. It is to be noted that the application running section 56 is implemented by the control section 11 executing a prescribed application program. The function of the alternative input request acceptance section 51 and the function of the alternative input request transmission section 52 may be implemented by an application program implementing the application running section 56, or may be implemented by another program such as a system program. Such programs may be provided to the information processing apparatus 10 over a communication network such as the internet, or may be provided by being stored in a computer readable information storage medium such as an optical disk.

In addition, the operation device 20 includes an alternative input request reception section 53, an operation data generation section 54, and an operation data transmission section 55, in terms of functions. These functions are implemented by executing a program included in the control circuit 21. This program also may be provided to the operation device 20 from the outside via the information processing apparatus 10, for example.

The alternative input request acceptance section 51 of the information processing apparatus 10 accepts a use request for an alternative input function from the user. An alternative input function refers to a function of using an operation member as an alternative to an operation input on another specific operation member disposed on the operation device 20. Specifically, in the present embodiment, the tilting operation member 27 is caused to alternatively accept an operation input performed on an operation member of a different category. In the following explanation, an operation member of a different category to which an alternative is used is referred to as a target operation member, and an operation member (here, tilting operation member 27) that is used as an alternative to a target operation member is referred to as an alternative operation member. If an alternative input function is used, the user is allowed to perform, to the information processing apparatus 10, an operation input the same as an operation input on a target operation member by operating an alternative operation member instead of actually operating the target operation member. This will be explained in detail later.

Specifically, the user can use the tilting operation members 27 as alternatives to the operation buttons 22 or the trigger buttons 25 which are different in categories from the tilting operation member 27, in the present embodiment. In addition, any one of the tilting operation members 27 can be used as an alternative to a plurality of the operation buttons 22 and a plurality of the trigger buttons 25. A manner of implementing the alternative input function will be explained later.

The alternative input request transmission section 52 of the information processing apparatus 10 transmits information (hereinafter, referred to as alternative input indication information) indicating the details of an alternative input function request accepted by the alternative input request acceptance section 51, to the operation device 20. The alternative input indication information includes at least information indicating a correspondence between target operation members and alternative operation members. A certain specific example will be given. In a case where a user requests an alternative input function of using the four functional buttons 23 as target operation members and using the tilting operation member 27R as an alternative operation member (that is, allocating the four functional buttons 23 to the tilting operation member 27R), alternative input indication information indicating the correspondence between these target operation members and the alternative operation member is transmitted to the operation device 20.

The alternative input request reception section 53 of the operation device 20 receives the alternative input indication information transmitted from the alternative input request transmission section 52 of the information processing apparatus 10, and temporarily stores the details of the received information in an internal memory of the control circuit 11. After the alternative input request reception section 53 receives the alternative input indication information, the operation device 20 continuously executes a process for implementing the alternative input function, which will be explained below. This process continues until an indication of cessation of use of the alternative input function is provided from the information processing apparatus 10.

The operation data generation section 54 of the operation device 20 scans the statuses of the operation members of the operation device 20 at regular intervals, and generates operation data D that describes a user operation on the basis of a result of the scanning. Particularly in the present embodiment, when a use request for an alternative input function is given, the operation data generation section 54 determines operation information that describes an operation for the target operation member according to a user operation performed on the alternative operation member, in view of alternative input indication information that is previously accepted. A certain specific example will be given. When alternative input indication information indicating to use the four functional buttons 23 as target operation members and use the tilting operation member 27R as an alternative operation member has been accepted, the operation data generation section 54 identifies what operation the user intends to perform for the four functional buttons 23 on the basis of the current status of the tilting operation member 27R, and generates the identification result as operation information indicating a description of an operation input for the four functional buttons 23. At this point, the operation data generation section 54 ignores the actual statuses of the four functional buttons 23 determined as the target operation members. Therefore, if the user unintentionally touches one of the target operation members and a certain status change occurs, this status change is not reflected in the operation data D. In addition, during running of the alternative input function, the operation data generation section 54 generates operation information indicating that no operation is performed on the alternative operation member (that is, operation information indicating that the tilting operation member 27 determined as the alternative operation member is in the neutral position).

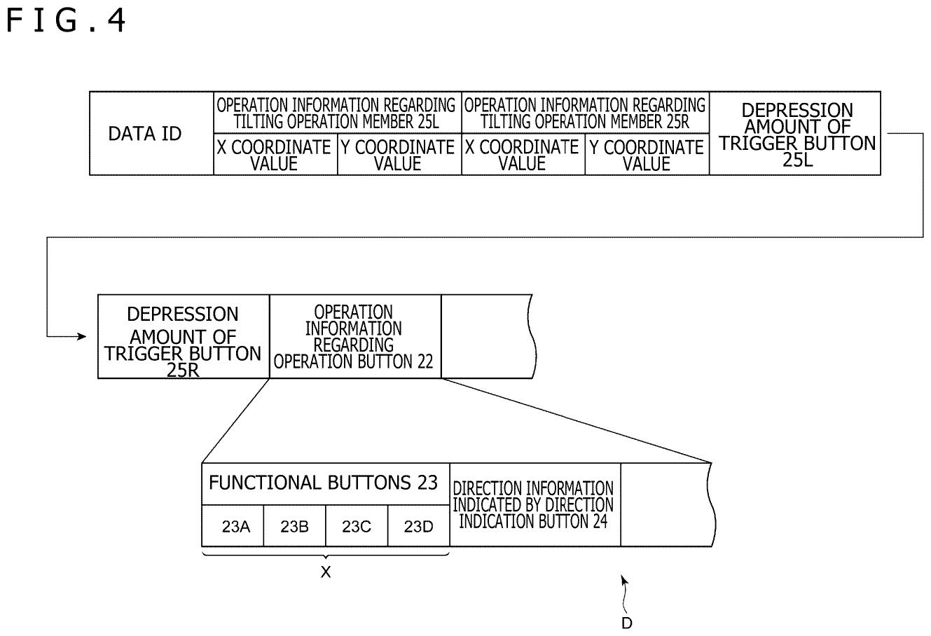

In the present embodiment, it is assumed that the operation data D is fixed-length data having a predetermined data format, and that what is indicated by information depends on a position where the information is stored in the operation data D. FIG. 4 is a diagram schematically depicting one example of the operation data D. In the example in FIG. 4, a data ID, operation information regarding the tilting operation member 27L, operation information regarding the tilting operation member 27R, operation information regarding the trigger button 25L, operation information regarding the trigger button 25R, operation information regarding the operation buttons 22, etc. are stored in the operation data D in this order from the top position.

Operation information regarding each of the tilting operation members 27 is expressed by 2D plane position coordinates indicating the position of the movable section of the tilting operation member 27. That is, operation information regarding each of the tilting operation members 27 is expressed by a set consisting of an X-axis coordinate value which represents an inclination in the left-right direction and a Y-axis coordinate value which represents an inclination in the up-down direction. Each of the coordinate values of the X and Y axes can be any value from 0 to 255. The coordinate values of the neutral position (point O) in the respective axes are 128 which is the median value. The operation data generation section 54 obtains measurement values representing inclinations of the tilting operation member 27 in the left-right direction and the up-down direction, normalizes the obtained measurement values within a range from 0 to 255, and determines the normalized values as the coordinate values of the X and Y axes. In the operation data D, a set of these coordinate values is stored as operation information indicating the operation performed on the tilting operation member 27.

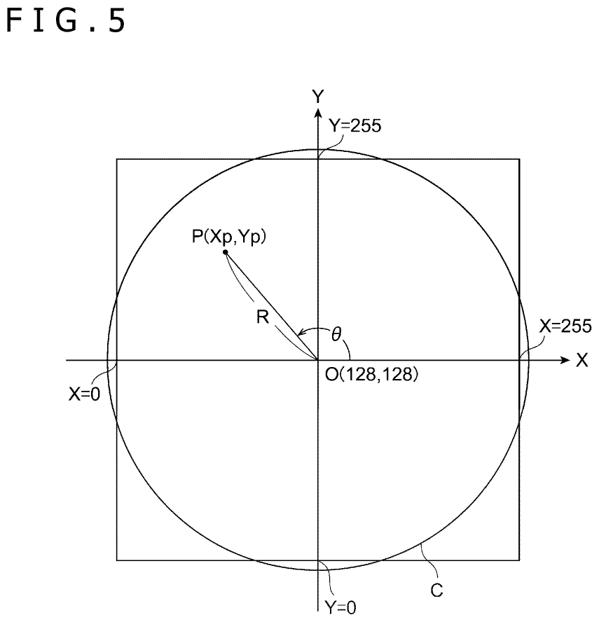

FIG. 5 is a diagram for explaining operation information regarding the tilting operation member 27, which is expressed by the above coordinate values. A point O in FIG. 5 corresponds to the neutral position. In a case where the tilting operation member 27 is not being operated by the user, the operation data generation section 54 obtains, as operation information regarding the tilting operation member 27, the coordinate values of the point O. When the user tilts the tilting operation member 27 toward the right direction, the coordinate value of the X axis increases. When the user tilts the tilting operation member 27 toward the left direction, the coordinate value of the X axis decreases. In addition, when the user tilts the tilting operation member 27 toward the upward direction, the coordinate value of the Y axis increases. When the user tilts the tilting operation member 27 toward the downward direction, the coordinate value of the Y axis decreases.

A circle C centered on the neutral position O in FIG. 5 is indicative of the movable range of the tilting operation member 27. The circle C corresponds to a range within which tilting of the tilting operation member 27 is physically restricted. Therefore, the coordinate values of the X axis and the Y axis can be a value ranging from 0 to 255. The coordinate values corresponding to a position outside the circle C in FIG. 5 are actually not outputted. It is to be noted that, in order to reliably output the minimum value or the maximum value as the coordinate value of one of the axes when the tilting operation member 27 is tilted to the up, down, left, or right direction to the maximum degree, a position where the coordinate value of each axis becomes maximum or minimum is defined slightly inside the circumference of the circle C.

The point P in FIG. 5 is one example of operation information regarding the tilting operation member 27. In this example, the position coordinates (Xp, Yp) of the point P are obtained as the operation information. The direction from the point O to the point P represents a direction (operation direction) toward which the user tilts the tilting operation member 27. The distance from the point O to the point P represents the tilting amount (operation amount). Hereinafter, it is assumed that a tilted direction of the tilting operation member 27 is expressed by an azimuth angle θ on condition that the X-axis positive direction is at 0 degrees and the counterclockwise direction is defined as a positive direction, and a tilting amount of the tilting operation member 27 is expressed by a distance R from the point O. By calculating the azimuth angle θ and the tilting amount R using the coordinate values of the X axis and the Y axis, the operation data generation section 54 can identify a tilting operation performed by the user.

Operation information regarding the trigger buttons 25L and 25R is expressed by numerical values that represent respective depression amounts. Here, operation information regarding each of the trigger buttons 25 is expressed by a numerical value ranging from 0 to 255. That is, when the trigger button 25 is not being operated, the operation data generation section 54 outputs 0 as operation information regarding the trigger button 25, and, when the trigger button 25 is depressed to the maximum degree, the operation data generation section 54 outputs 255 as operation information regarding the trigger button 25.

Regarding the direction indication buttons 24 of the operation buttons 22, each of the direction indication buttons 24 may be operated individually in the above-mentioned manner, or adjacent two of the direction indication buttons 24 may be depressed simultaneously. Therefore, on the basis of which one of the four direction indication buttons 24 is depressed, the operation data generation section 54 determines which direction of eight directions is indicated by the user, or determines that none of the directions is indicated by the user, and generates operation data D that includes operation information (indicated direction information) indicating a result of the determination.

Operation information regarding the remaining operation buttons 22 is expressed by logical values which indicate whether the respective operation buttons 22 have been depressed. For example, when any one of the operation buttons 22 is not depressed, the operation data generation section 54 outputs 0 as operation information regarding the operation button 22, and, when the operation button 22 is depressed, the operation data generation section 54 outputs 1 as operation information regarding the operation button 22.

Here, in a case where a use request for the alternative input function is given, the operation data generation section 54 determines operation information regarding the target operation member in the operation data D according to an operation performed on the alternative operation member. Since the tilting operation member 27 is used as the alternative operation member in the present embodiment, as previously explained, the operation data generation section 54 determines operation information regarding the target operation member, according to the directions and/or amounts of a user operation performed on the tilting operation member 27 which is an alternative operation member. For example, according to the amount of a user operation performed on the alternative operation member, the operation data generation section 54 determines whether or not to add operation information indicating an operation on the target operation member, to the operation data D. Further, in a case where one alternative operation member is used as an alternative to a plurality of target operation members, operation information indicating an operation on one of the target operation members, which is determined by the direction of a user operation performed on the alternative operation member, may be included in the operation data D. In one example, in a case where a use request for the alternative input function of using the tilting operation member 27R as an alternative to the four functional buttons 23 is given, the operation data generation section 54 determines operation information (X in FIG. 4) for indicating whether each of the functional buttons 23 is depressed or not, according to a description of an operation performed on the tilting operation member 27R (the direction and amount of the operation). It is to be noted that specific examples of processes in which the operation data generation section 54 determines operation information regarding a target operation member according to a description of a user operation performed on an alternative operation member, will be explained later.

Meanwhile, regardless of an actual operation direction, the operation data generation section 54 determines, as operation information regarding the alternative operation member, information that indicates that no operation is performed (the X-axis coordinate value being 128 and the Y-axis coordinate value being 128). Since the operation data generation section 54 determines operation information regarding a target operation member to be included in the operation data D, according to an operation performed on the alternative operation member in the above-mentioned manner, the generated operation data D can be necessarily in the same format, irrespective of whether or not an alternative input function is used, or for which target operation member/with which alternative operation member an alternative input is performed.

The operation data transmission section 55 transmits the latest operation data D generated by the operation data generation section 54 to the information processing apparatus 10 at regular intervals. The operation data generation process and the operation data transmission process are performed by the operation data generation section 54 and the operation data transmission section 55 at regular intervals, respectively, whereby a description of the latest user operation is reported to the information processing apparatus 10. It is to be noted that, even in a case where a use request for an alternative input function is given, the operation data transmission section 55 may further transmit operation information regarding position coordinates acquired for the alternative operation member, together with the operation data D.

The application running section 56 of the information processing apparatus 10 executes an application program, and performs processes including a game process according to a description of a user operation. The application running section 56 performs a process according to a user operation by making reference to the direction of the operation data D transmitted from the operation data transmission section 55. The data format of the operation data D is not altered according to whether the alternative input function is used or is not used, as previously explained. Therefore, it is sufficient that the application running section 56 uses the operation data D directly as data indicating a description of a user operation input, irrespective of whether the alternative input function is used or is not used. It is not necessary for the application running section 56 to change processing according to use of the alternative input function. That is, an application program that the application running section 56 executes is not necessarily prepared for the alternative input function.

A few specific examples of a manner in which the operation data generation section 54 determines operation information regarding a target operation member according to an operation performed on an alternative operation member, will be explained below.

A first example is a case where the tilting operation member 27 is used as an alternative to one operation button 22. In this case, in a case where the user tilts the tilting operation member 27 determined as the alternative operation member by a prescribed threshold tilting amount Rth or more, the operation data generation section 54 determines a user operation of depressing the operation button 22 determined as the target operation member.

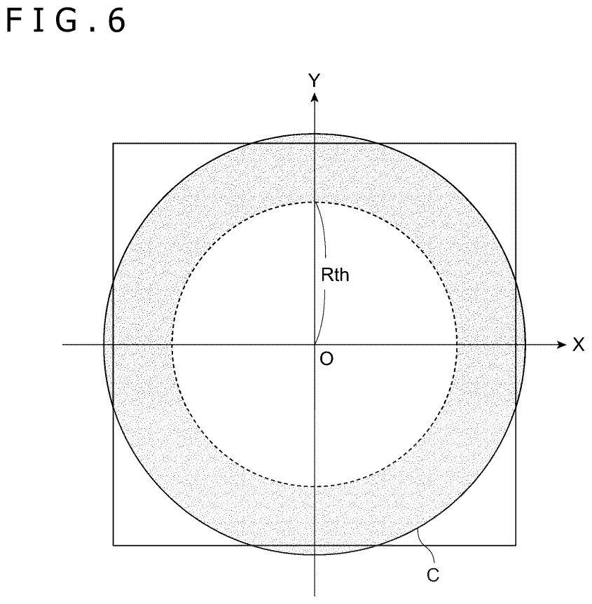

FIG. 6 is a diagram for explaining operations performed on an alternative operation member a depression of a target operation member which is determined in this example. Specifically, a hatched portion in FIG. 6 indicates position coordinates within which an operation of depressing a target operation member is determined. A portion inside the hatched portion indicates position coordinates within which an operation of depressing a target operation member is not determined. The hatched portion indicates a region in which the tilting amount R≥Rth.

In this example, when the user performs an operation of tilting the alternative operation member toward a direction to which the alternative operation member can be easily operated by the user, an operation input that is equivalent to an operation of depressing the target operation member can be performed on the information processing apparatus 10. In addition, when an operation of restoring the original position of the tilted alternative operation member is performed, recognition that the depressing operation on the target operation member is finished, is provided. In particular, the tilting operation member 27 is automatically restored to the neutral position when the user hand is released from the tilting operation member 27. Accordingly, the operation data generation section 54 determines that the depressing operation on the target operation member is finished. Therefore, by releasing the finger from the tilting operation member 27 after tilting the tilting operation member 27, the user can provide recognition that the depressing operation is finished, to the information processing apparatus 10, in the same manner as the user finishes a depressing operation on the operation button 22 by releasing a finger after depressing the operation button 22.

It is to be noted that the threshold tilting amount Rth may be a predetermined value. Alternatively, the threshold tilting amount Rth may be a value that can be changed according to a user indication received by the alternative input request acceptance section 51 of the information processing apparatus 10. Specifically, for example, the alternative input request acceptance section 51 accepts designation of a magnitude of the threshold tilting amount Rth as well as an execution request for the alternative input function from the user, and the operation data generation section 54 determines the magnitude of the threshold tilting amount Rth according to the designation accepted from the user. When the threshold tilting amount Rth is large, the tilting operation member 27 has to be tilted greatly to input a depression operation of the operation button 22. This reduces the possibility of erroneous inputs. In contrast, when the threshold tilting amount Rth is small, it is sufficient to slightly tilt the tilting operation member 27 to input a depression operation of the operation button 22. This increases the sensitivity of an operation.

In addition, only one value is used as the threshold tilting amount Rth in the above example, but different values may be used for the threshold tilting amount Rth for determining that the depressing operation is started and the threshold tilting amount Rth for determining that the depressing operation is finished. In particular, if the threshold tilting amount Rth for determining that the depressing operation is started is set to be larger than the threshold tilting amount Rth for determining that the depressing operation is finished, a determination on consecutive depressing operations is unlikely to be made. Accordingly, a chattering phenomenon or the like can be suppressed.

Next, a second example in which the tilting operation member 27 is used as an alternative to a plurality of the operation buttons 22 will be explained. In this example, the operation data generation section 54 determines which one of the operation buttons 22 is depressed, according to the direction (operation direction) of a user operation of tilting the tilting operation member 27.

More specifically, for each of the operation buttons 22 which are target operation members, the operation data generation section 54 previously defines a corresponding range of the azimuth angle θ (corresponding direction range). Further, in a case where the user performs an operation of tilting the alternative operation member, when the azimuth angle θ of the tilting operation falls within any one of the corresponding direction ranges, it is determined that a user operation on the operation button 22 that corresponds to the corresponding direction range that includes the azimuth angle θ is performed. Here, the operation data generation section 54 refers to not only the azimuth angle θ of the tilting operation but also the magnitude of the tilting amount R. When the tilting amount R is equal to or greater than a threshold tilting amount Rth, the operation data generation section 54 determines a user operation of depressing the operation button 22 that corresponds to the azimuth angle θ, in the same manner as in the first example. On the other hand, when the tilting amount R is less than the threshold tilting amount Rth, the operation data generation section 54 determines non-operation of the target operation members.

As a specific example, a case where the four functional buttons 23 are defined as target operation members while the tilting operation member 27L is defined as an alternative operation member, will be explained. In this case, rightward, upward, leftward, and downward tilting operations on the tilting operation member 27L are used as alternatives to the functional buttons 23A, 23B, 23C, and 23D, respectively, so as to perform correspondence to actual arrangement of the functional buttons 23 on a surface of the operation device 20.

If every direction of 360 degrees to which a tilting operation can be performed is allocated to any one of the plurality of operation buttons 22, there is a possibility that a determination that an operation for the operation button 22 corresponding to the adjacent corresponding range is performed is erroneously made around a boundary between the corresponding direction ranges corresponding to the operation buttons 22. For this reason, the operation data generation section 54 may define a buffer range corresponding to none of the operation buttons 22, between two adjacent corresponding direction ranges in order to inhibit the corresponding direction ranges corresponding to the operation buttons 22 which are target operation members from directly adjoining each other. When the azimuth angle of a tilting operation falls within the buffer range, the operation data generation section 54 determines that none of the target operation members is operated by the user, in the same manner as when the tilting amount R is less than the threshold tilting amount Rth.

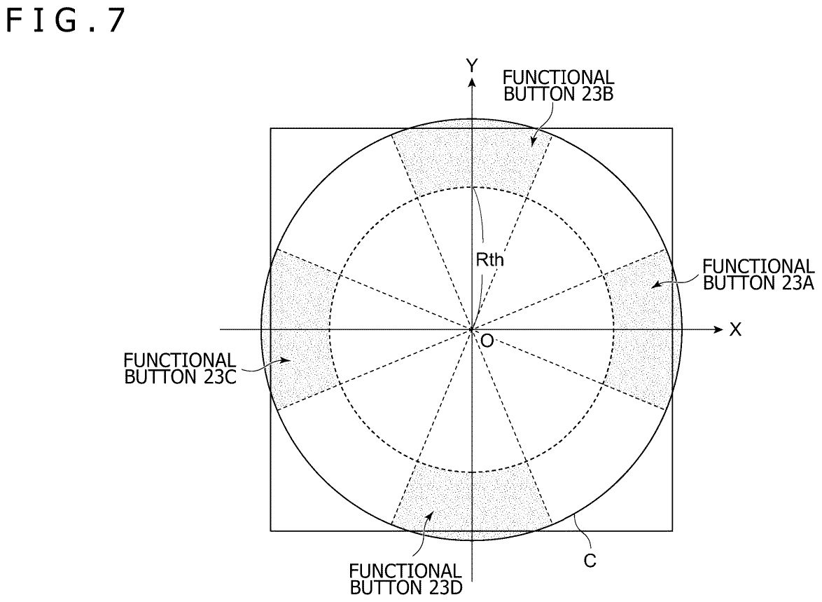

FIG. 7 is a diagram for explaining a relation between an operation direction of an actual user operation of tilting an alternative operation member and an operation on a target operation member to be determined by the operation data generation section 54 in this example. In addition, table 1 depicts the correspondence between an operation direction range and a target operation member. In the example depicted in FIG. 7, a corresponding direction range of 45 degrees is allocated for each of the four target operation members, and 45-degrees buffer ranges are defined between the corresponding direction ranges.

TABLE 1

| Range of | |
|---|---|
| Operation direction | Description of Operation input |
| 337.5° ≤ θ < 360°, | Functional button 23A is depressed |
| 0° ≤ θ < 22.5° | |
| 22.5° ≤ θ < 67.5° | Not operated |
| 67.5° ≤ θ < 112.5° | Functional button 23B is depressed |
| 112.5° ≤ θ < 157.5° | Not operated |
| 157.5° ≤ θ < 202.5° | Functional button 23C is depressed |
| 202.5° ≤ θ < 247.5° | Not operated |
| 247.5° ≤ θ < 292.5° | Functional button 23D is depressed |
| 292.5° ≤ θ < 337.5° | Not operated |

It is to be noted that, also in a case where an alternative to the plurality of operation buttons 22 is used, the magnitude of the threshold tilting amount Rth may be changed, in the same manner as in a case where an alternative to one operation button 22 is used. Moreover, different values may be defined as magnitudes of the threshold tilting amount Rth for the respective corresponding direction ranges in accordance with a user's instruction or the like. For example, in a case where it is easy for the user to tilt the tilting operation member 27 toward the up direction but is not easy for the user to tilt the tilting operation member 27 toward the down direction, the magnitudes of the threshold tilting amounts Rth for the respective corresponding direction ranges are determined such that the threshold tilting amount Rth for the corresponding direction range that is set in the up direction is a relatively large value while the threshold tilting amount Rth for the corresponding direction range that is set in the down direction is a relatively small value. Accordingly, an operation input through the operation button 22 that corresponds to the corresponding direction range in the down direction can be performed by a slight tilting operation.

In addition, the size of the buffer ranges may be predetermined, but may be changed in accordance with a user's instruction or the like. Specifically, when accepting an execution request for an alternative input function from the user, for example, the alternative input request acceptance section 51 may further accept a designation of widening, narrowing, or eliminating a buffer range, and the operation data generation section 54 may determine the size of the buffer range in accordance with the designation accepted from the user.

Further, the sizes and the positions of the corresponding direction ranges corresponding to the operation buttons 22 and the size of a buffer range disposed therebetween may also be separately determined in according with a user's instruction or the like. For example, in a case where it is easy for the user to tilt the tilting operation member 27 toward the right direction, the corresponding direction ranges of the plurality of operation buttons 22 which are target operation members are defined within the right half range (where the azimuth angle θ satisfies 0≤θ≤90° and 270°≤θ<360°), and the left half range (90°<θ<270°) is entirely defined as a buffer range. Accordingly, only by tilting the tilting operation member 27 toward the right side, the user can perform an operation input on each of the plurality of target operation members.

In addition, the operation data generation section 54 may determine a correspondence between a range between two adjacent corresponding direction ranges and an operation of simultaneously depressing the two target operation members. As a specific example, a case where the tilting operation member 27R is used as an alternative to the four direction indication buttons 24 will be explained. In a case where the direction indication buttons 24 are used to indicate a direction, the user may depress two adjacent direction indication buttons 24 simultaneously to indicate an intermediate direction between the directions corresponding to the two direction indication buttons 24, in the above-mentioned manner. Therefore, the operation data generation section 54 brings an intermediate range between the corresponding direction ranges that correspond to the two adjacent direction indication buttons 24, into correspondence with an operation of simultaneously depressing the two direction indication buttons 24. Accordingly, by using the alternative operation member, the user can perform not only an operation of depressing any one of the operation buttons 22 but also an operation of simultaneously depressing two adjacent operation buttons 22.

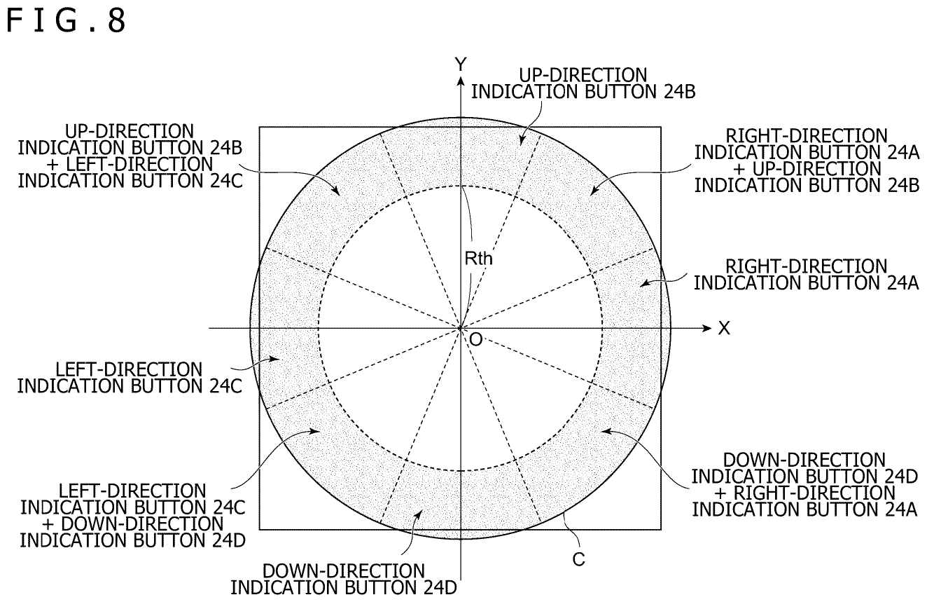

FIG. 8 is a diagram for explaining the correspondence between a description of an actual user operation on an alternative operation member and a description of an operation on target operation members to be determined by the operation data generation section 54 in this example. In addition, table 2 depicts a relation between operation direction ranges and descriptions of the corresponding operations in this example. In this depicted example, intermediate ranges between the corresponding direction ranges corresponding to the adjacent direction indication buttons 24 are defined in place of the buffer ranges in FIG. 7. When an operation of tilting the tilting operation member 27 into the intermediate range is performed, the operation data generation section 54 generates the operation data D that indicates simultaneous depression of the two corresponding direction indication buttons 24.

TABLE 2

| Range of | |
|---|---|
| Operation direction | Description of Operation input |
| 337.5° ≤ θ < 360°, | Right-direction indication button 24A is |
| 0° ≤ θ < 22.5° | depressed |
| 22.5° ≤ θ < 67.5° | Right-direction indication button 24A |
| | and Up-direction indication button 24B |
| | are depressed |
| 67.5° ≤ θ < 112.5° | Up-direction indication button 24B is |
| | depressed |
| 112.5° ≤ θ < 157.5° | Up-direction indication button 24B and |
| | Left-direction indication button 24C are |
| | depressed |
| 157.5° ≤ θ < 202.5° | Left-direction indication button 24C is |
| | depressed |
| 202.5° ≤ θ < 247.5° | Left-direction indication button 24C and |
| | Down-direction indication button 24D |
| | are depressed |
| 247.5° ≤ θ < 292.5° | Down-direction indication button 24D is |
| | depressed |
| 292.5° ≤ θ < 337.5° | Down-direction indication button 24D |
| | and Right-direction indication button |
| | 24A are depressed |

It is to be noted that the operation data generation section 54 may determine an operation on a target operation member by considering not only the latest position of the tilting operation member 27 but also information regarding the past positions. For example, in the example depicted in FIG. 8, the user operates the tilting operation member 27 toward the right direction, and then, operates the tilting operation member 27 to the left direction to a certain degree. In this case, even if the tilting amount R of the tilting operation does not reach the threshold tilting amount Rth, an inference that the user intends to perform an operation input to indicate the left direction may be made. Therefore, the operation data generation section 54 may calculate the moving speed of the position coordinates of the tilting operation member 27 by referring to time-series data about the position coordinates, and, when movement to a prescribed direction is performed at a moving speed equal to or higher than a prescribed threshold, depression of the direction indication button 24 that corresponds to the direction may be determined. Alternatively, a moving direction of the tilting operation member 27 is changed and an amount of movement starting from the change point becomes equal to or greater than a prescribed value, depression of the direction indication button 24 that corresponds to a corresponding direction range including the azimuth angle θ of the direction of the movement starting from the change point, may be determined.

Next, an explanation of a third example will be given. In the third example, which is similar to the second example, one tilting operation member 27 is used as an alternative to the plurality of operation buttons 22. In the third example, however, the operation data generation section 54 determines the operation button 22 for which an operation is performed, on the basis of both the direction (operation direction) and the tilting amount R (operation amount) of a tilting operation.

Specifically, in the third example, corresponding ranges corresponding to the plurality of operation buttons 22 are not determined with respect to only the azimuth angle θ which indicates the direction of a user operation, but are determined with respect to both the azimuth angle θ and a tilting amount R which indicates the amount of an operation. When determining that both the azimuth angle θ indicating the direction of an operation and a tilting amount R indicating the amount of the operation are within the corresponding range of any one of the operation buttons 22, the operation data generation section 54 generates operation data D that indicates depression of the operation button 22.

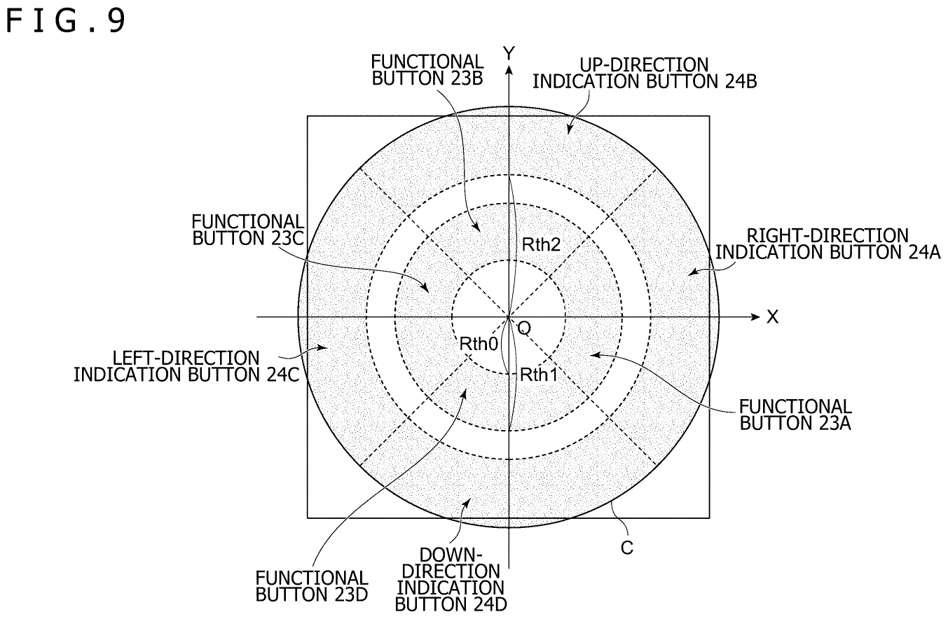

FIG. 9 is a diagram depicting one example of the correspondences between descriptions of operations on alternative operation members and target operation members in the third example. In the depicted example, the eight operation buttons 22 which are the four functional buttons 23A, 23B, 23C, and 23D and the four direction indication buttons 24A, 24B, 24C, and 24D are defined as operation target members. On the basis of the position of one tilting operation member 27, the operation data generation section 54 determines for which one of the eight operation target members an operation is performed.

For example, the functional button 23B and the up-direction indication button 24B each correspond to the same numerical range of the azimuth angle θ of 45°≤θ<135° in the example in FIG. 9. However, the functional button 23B corresponds to the numerical range of the tilting amount R of Rth0≤R≤Rth1 while the up-direction indication button 24B corresponds to the numerical range of R≥Rth2. Here, Rth0, Rth1, and Rth2 represent respective prescribed threshold tilting amounts, and Rth0<Rth1<Rth2. Accordingly, even in a case where the user tilts the tilting operation member 27 to the up direction, when the magnitude of the tilting amount R is Rth0 to Rth1, an operation on the functional button 23B is determined, and, when the magnitude of the tilting amount R is equal to or greater than Rth2, an operation on the up-direction indication button 24B is determined. Regarding the other directions, which operation button 22 is operated is determined according to the magnitude of the tilting amount in the similar manner.

It is to be noted that a numerical range where the tilting amount R is greater than the threshold Rth1 but is less than the threshold Rth2 in this example is determined as a buffer range as in the second example, and, when the tilting amount R falls within this numerical range, non-operation of all the operation buttons 22 is determined. In addition, also in the third example, a buffer range (not depicted in FIG. 9) for an azimuth angle θ at which non-operation of all the operation buttons 22 is determined, may be defined between corresponding ranges that are adjacent to each other in the circumferential direction, in the similar manner as in the example in FIG. 7. Furthermore, an intermediate range where a simultaneous operation of the operation buttons 22 is determined, may be defined between two corresponding ranges that correspond to respective operation buttons 22, in the similar manner as in the example in FIG. 8.

In this example, to determine the up-direction indication button 24B as an operation target, for example, the user tilts the tilting operation member 27 from the home position toward the up direction. During this operation, the tilting operation member 27 necessarily passes through a corresponding range that corresponds to the functional button 23B. Here, an operation of the functional button 23B may be instantly determined against the user's intension, but such determination is not desirable.

For this reason, in a case where a changing speed of the position of the tilting operation member 27 (i.e. a movement amount of the movable section of the tilting operation member 27 per unit time) becomes equal to or less than a prescribed threshold, the operation data generation section 54 may determine which target operation member is subjected to user operation, on the basis of the position of the tilting operation member 27 at this point of time. In this case, the operation data generation section 54 determines non-operation of all the operation buttons 22 when the user is quickly operating the tilting operation member 27. If the user stops the tilting operation member 27 at a certain position, the operation data generation section 54 determines an operation of the target operation member that corresponds to a region including the position. In addition, wherever the user moves the tilting operation member 27 to, the tilting operation member 27 is restored to the home position when the user hand is released from the tilting operation member 27. Also in this case, the operation data generation section 54 disregards a corresponding range through which the tilting operation member 27 passes when restoring to the home position. It is to be noted that, the determination criterion explained herein for determining an operation of a specific target operation member in a case where the changing speed becomes equal to or less than the prescribed threshold may be applied to the above-mentioned first and second examples.

In addition, also in the third example, the thresholds that the operation data generation section 54 uses to make a determination and the positions and the sizes of respective corresponding ranges that correspond to the operation buttons 22, may be changeable in accordance with a user instruction or the like, in the similar manner as in the second example, etc. In addition, the threshold for the changing speed may vary according to the corresponding ranges. For example, a threshold for a changing speed for determining an operation on an operation button 22 that corresponds to a corresponding range, may be made different between an inner corresponding range that corresponds to the functional buttons 23 and an outer corresponding range that corresponds to the direction indication buttons 24.

Next, a fourth example in which the tilting operation member 27 is used as an alternative to the trigger button 25 will be explained. In this example, the operation data generation section 54 determines a depression amount of the trigger button 25 according to the tilting amount R of the tilting operation member 27 tilted by the user.

In one example, the operation data generation section 54 may obtain the depression amount of the trigger button 25 by multiplying the value of the tilting amount R by a prescribed coefficient. This coefficient is determined in such a way that the maximum value of the tilting amount R matches the maximum value of the depression amount. Accordingly, the user can perform an operation input to the trigger button 25 by tilting the tilting operation member 27 toward any direction.

Here, a relation between the tilting amount R of the alternative operation member and the depression amount of the target operation member is not limited to a proportional relation, and may be a non-linear relation. For example, play may be provided to the trigger buttons 25 and a depression amount of 0 (that is, no operation input to the trigger button 25 is performed) may be determined until the movable section is depressed by a certain amount. In this case, even when the alternative input function is used, a depression amount of 0 may be determined until the tilting amount R of the alternative operation member exceeds a prescribed value. In addition, for example, the depression amount of the target operation member may be obtained using different coefficients for the numerical value ranges of the tilting amount R to realize such a change that the depression amount is not greatly increased when the tilting amount R is small, and the depression amount is abruptly increased when the tilting amount R is increased to some extent. In addition, a high-order function such as a quadric function may be used to obtain the depression amount from the tilting amount R. In either case, the operation data generation section 54 calculates a value of the depression amount in such a way that the depression amount is minimum (here, 0) when the tilting amount R is 0, and the depression amount is maximum (here, 255) when the tilting amount R is maximum. Accordingly, by controlling the tilting amount R of the alternative operation member, the user can perform, on the trigger button 25, operation inputs ranging from the minimum value to the maximum value.

It is to be noted that the operation data generation section 54 may determine the value of the depression amount on the basis of the past time-series data in addition to the latest value of the tilting amount R. For example, to perform noise elimination to disregard minute variations of the tilting amount R, the operation data generation section 54 may perform prescribed digital filtering on the past time-series data about the tilting amount R, and may obtain the depression amount using the digital-filtered tilting amount R.

In addition, one alternative operation member is used as an alternative to one trigger button 25 in the above explanation, but one alternative operation member may be used as an alternative to a plurality of the trigger buttons 25. In this case, respective corresponding direction ranges of the azimuth angle θ corresponding to the plurality of trigger buttons 25 are defined, in the similar manner as in the second example. For example, in a case where a corresponding direction range in the right direction and a corresponding direction range in the left direction are brought into correspondences with the trigger button 25R and the trigger button 25L, respectively, the user can realize an operation input to the trigger button 25R by tilting the alternative operation member to the right direction, and can realize an operation input to the trigger button 25L by tilting the alternative operation member to the left direction.

In the present embodiment, the force presenting mechanism 26 is connected to the trigger button 25, and a force is presented to the user who is operating the trigger button 25, as previously explained. However, in a case where the tilting operation member 27 is used as an alternative to the trigger button 25, the user does not actually operate the trigger button 25. Therefore, even if the force presenting mechanism 26 is activated, a force cannot be presented to the user. For this reason, in a case where an execution for an alternative input function of determining, as a target operation member, an operation member (here, the trigger button 25) to which a force is to be presented is requested, the control circuit 21 may disregard an instruction for force presentation to the target operation member, and may refrain from controlling the force presenting mechanism 26.

As explained so far, in the operation device 20 according to the present embodiment, the tilting operation members 27 can be used as alternative operation members to realize operation inputs to the operation buttons 22 and the trigger buttons 25. Accordingly, the user can realize an operation input to the information processing apparatus 10 in a free and user-friendly manner.

It is to be noted that the embodiment of the present invention is not limited to those explained above. In the above explanation, the operation device 20 is a controller of a home-use game machine. However, for example, the operation device 20 may be any device that accepts a user operation. Also, the categories, number, positions, etc. of the operation members included in the operation device 20 in the above explanation are just examples. The operation device 20 may include any number of operation members of each category as long as at least one operation member that can be used as an alternative operation member is included.

In addition, the above explanation has described a case of using the alternative operation member as an alternative to one operation button 22, a case of using the alternative operation member as an alternative to four operation buttons 22, and a case of using the alternative operation member as an alternative to eight operation buttons 22. However, one alternative operation member may be used as an alternative to any number of the operation buttons 22.

In addition, the force presenting mechanism 26 presents a force to the user when the user operates the trigger button 25 in the above explanation. However, the force presenting mechanism 26 may present a force to the user when the user operates the operation button 22. Also in this case, during use of the alternative input function, control of the force presenting mechanism 26 presenting a force to the target operation member of the alternative input function may be stopped.

In addition, the tilting operation members 27 are used as alternative operation members in the above explanation. However, a direction indication operation member a movable section of which is subjected to a user depression operation toward any direction so as to indicate a direction, can also be used as an alternative operation member. In a specific example, a slide operation member that is not tilted but is slidingly moved in a direction parallel with the main body of the operation device 20 so as to indicate any direction, has been known. Such a slide operation member can also be used to perform an alternative input for the operation buttons 22 and the trigger buttons 25 with use of information regarding an operation direction and an operation amount of the slide operation member by the above-mentioned method.

In addition, a use request for the alternative input function is given by an operation input to the information processing apparatus 10 in the above explanation. However, a use request for the alternative input function may be directly given to the operation device 20 through an operation on a switch disposed on the operation device 20, for example. In this case, by previously operating the switch, the user can make a use request for the alternative input function associated with the switch, to the operation device 20. Also in this case, the application running section 56 of the information processing apparatus 10 can perform a process corresponding to operation data D to be transmitted, irrespective of whether or not the alternative input function is under execution in the operation device 20.

In addition, the operation device 20 is directly connected to the information processing apparatus 10 in the above explanation. However, the operation device 20 may be connected to the information processing apparatus 10 via a communication network or the like. In a cloud type service, for example, the operation device 20 may be directly connected to a relay apparatus, and a server apparatus connected to the relay apparatus via a communication network such as the internet may function as the information processing apparatus 10 of the embodiment of the present invention. In this case, the relay apparatus receives operation data D indicating a user operation performed on the operation device 20 from the operation device 20, and transmits the operation data D to the information processing apparatus 10. Also in this case, the information processing apparatus 10 can execute a process of an application program by referring to the operation data D received from the relay apparatus, in a similar manner as in the above-mentioned embodiment.

In addition, the functions that have been implemented by the information processing apparatus 10 in the above explanation, may be implemented by a plurality of computers. In one example, the function of the alternative input request acceptance section 51 and the function of the alternative input request transmission section 52 may be implemented by a client apparatus that is directly connected to the operation device 20 while the function of the application running section 56 may be implemented by a server apparatus that is connected via a connection network to the client apparatus.

### REFERENCE SIGNS LIST

1: Information processing system
10: Information processing apparatus
11: Control section
12: Storage section
13: Interface section
20: Operation device
21: Control circuit
22: Operation button
23: Functional button
24: Direction indication button
25: Trigger button
26: Force presenting mechanism
27: Tilting operation member
51: Alternative input request acceptance section
52: Alternative input request transmission section
53: Alternative input request reception section
54: Operation data generation section
55: Operation data transmission section
56: Application running section

1. An operation device that is connected to an information processing apparatus, the operation device comprising:
a direction indication operation member that is subjected to a user depression operation toward any direction;
an operation member that is different in category from the direction indication operation member;
an operation data generation section that generates operation data that includes operation information describing operations on the direction indication operation member and the operation member of the different category; and
an operation data transmission section that transmits the operation data to the information processing apparatus, wherein,
in a case where a use request for an alternative input function of using the direction indication operation member as an alternative to the operation member of the different category is given, the operation data generation section identifies operation information describing an operation on the operation member of the different category to be included in the operation data, according to a user operation performed on the direction indication operation member.

2. The operation device according to claim 1, wherein, in a case where a use request for the alternative input function is given, the operation data generation section generates the operation data that includes operation information indicating that no user operation has been performed on the direction indication operation member.

3. The operation device according to claim 1, further comprising:
a force presenting mechanism that presents a force to the user who is operating the operation member of the different category, in accordance with an instruction given by the information processing apparatus; and
a control section that, in a case where a use request for the alternative input function of using the direction indication operation member as an alternative to the operation member of the different category is given, restricts control over force presentation that is performed by the force presenting mechanism to the operation member of the different category.

4. The operation device according to claim 1, wherein a description of the user operation on the direction indication operation member includes the direction of the operation and/or an amount of the operation.

5. The operation device according to claim 4, wherein, according to the amount of the user operation performed on the direction indication operation member, the operation data generation section decides whether or not to add operation information indicating an operation on the operation member of the different category, to the operation data.

6. The operation device according to claim 5, wherein
the operation device includes, as the operation member of the different category, an operation button that is subjected to a user depression operation, and,
in a case where the amount of the user operation performed on the direction indication operation member is equal to or greater than a prescribed threshold, the operation data generation section generates the operation data that includes operation information indicating depression of the operation button.

7. The operation device according to claim 6, wherein the prescribed threshold is a value that is changeable in accordance with an instruction given by the user.

8. The operation device according to claim 4, wherein
the operation device includes, as the operation member of the different category, a plurality of target operation members, and
the operation data generation section generates the operation data that includes operation information indicating an operation on one or more of the plurality of target operation members that are determined according to the direction of the user operation performed on the direction indication operation member.

9. The operation device according to claim 8, wherein
the operation device includes, as the plurality of target operation members, a plurality of operation buttons that are subjected to a user depression operation, and
the operation data generation section previously determines a corresponding range of an operation direction of the direction indication operation member corresponding to each of the plurality of operation buttons, and, in a case where the direction of the user operation performed on the direction indication operation member is within one of the corresponding ranges, the operation data generation section generates the operation data that includes operation information indicating depression of the operation button corresponding to the corresponding range.

10. The operation device according to claim 9, wherein, in a case where the user operation on the direction indication operation member is performed at a moving speed that is equal to or higher than a prescribed threshold, the operation data generation section selects a target operation member for which operation information indicating an operation is to be included in the operation data, in accordance with the direction of the operation performed on the direction indication operation member.

11. The operation device according to claim 9, wherein, in a case where a position of the direction indication operation member is changed, by a movement amount that is equal to or greater than a prescribed threshold, from a start point of a movement direction change of the direction indication operation member, the operation data generation section selects a target operation member for which operation information indicating an operation is to be included in the operation data, in accordance with the movement direction from the start point.

12. The operation device according to claim 9, wherein the corresponding range is determined on a basis of both a direction and an amount of a user operation performed on the direction indication operation member, and,
in a case where the direction and the amount of the user operation on the direction indication operation member are within the corresponding range, the operation data generation section generates the operation data that includes operation information indicating depression of the operation button corresponding to the corresponding range.

13. The operation device according to claim 12, wherein, in accordance with the direction and the amount of the user operation performed under a state where a change speed of a position of the direction indication member is equal to or less than a prescribed value, the operation data generation section selects a target operation member for which operation information indicating an operation is to be included in the operation data.

14. The operation device according to claim 9, wherein a position and/or a size of the corresponding range of the operation direction corresponding to each of the plurality of operation buttons is determined in accordance with an instruction given by the user.

15. The operation device according to claim 9, wherein the operation data generation section defines, between two adjacent corresponding ranges, a buffer range that does not correspond to any of the operation buttons, and, in a case where the direction of the user operation performed on the direction indication operation member is within the buffer range, the operation data generation section generates the operation data that includes operation information indicating non-depression of any of the operation buttons.

16. The operation device according to claim 9, wherein the operation data generation section defines an intermediate range between two adjacent corresponding ranges, and, in a case where the direction of the user operation performed on the direction indication operation member is within the intermediate range, the operation data generation section generates the operation data that includes operation information indicating simultaneous depression of two operation buttons corresponding to the two corresponding ranges.

17. The operation device according to claim 4, wherein
the operation device includes, as the operation member of the different category, a trigger button a depression amount of which is measured when the user performs a depression operation on the trigger button, and
the operation data generation section calculates the depression amount of the trigger button according to the amount of the user operation performed on the direction indication operation member, and generates the operation data that includes a value of the calculated depression amount as a description of the operation on the trigger button.

18. An information processing apparatus that is connected to an operation device including a direction indication operation member that is subjected to a user depression operation toward any direction, and an operation member that is different in category from the direction indication operation member, the information processing apparatus comprising:
an acceptance section that accepts, from the user, a use request for an alternative input function of using the direction indication operation member as an alternative to the operation member of the different category; and
a transmission section that transmits information describing the accepted use request to the operation device.

19. An information processing method for causing a computer to execute a method, the computer being connected to an operation device including a direction indication operation member that is subjected to a user depression operation toward any direction, and an operation member that is different in category from the direction indication operation member, the method comprising:
accepting, from the user, a use request for an alternative input function of using the direction indication operation member as an alternative to the operation member of the different category; and
transmitting information describing the accepted use request to the operation device.

20. A non-transitory computer readable storage medium containing a program for causing a computer to execute a method, the computer being connected to an operation device including a direction indication operation member that is subjected to a user depression operation toward any direction, and an operation member that is different in category from the direction indication operation member, the method comprising:
accepting, from the user, a use request for an alternative input function of using the direction indication operation member as an alternative to the operation member of the different category; and
transmitting information describing the accepted use request to the operation device.
